(19) United States
(12) Patent Application Publication
(10) Pub. No.: US 2003/0087031 A1
(43) Pub. Date: May 8, 2003

(54) Method for protecting and consolidating calcareous materials

(76) Inventors: Irving Slavid, Colebrook, CT (US); Norman Weiss, Colebrook, CT (US)

Correspondence Address: LAW OFFICE OF HERBERT A. NEWBORN, 7 EVERETT PAINE BLVD., MARBLEHEAD, MA, 01945, US

(21) Appl. No.: 10/167,363

(22) Filed: Jun. 11, 2002

Related U.S. Application Data
(63) Continuation-in-part of application No. 09/852,975, filed on May 10, 2001, now abandoned.
Application No. 09/852,975 is a continuation of application No. 09/428,713, filed on Oct. 28, 1999, now Pat. No. 6,296,905.
(60) Provisional application No. 60/106,144, filed on Oct. 29, 1998.

(51) Int. Cl. B05D 7/00

(52) U.S. Cl. 427/212

(57) ABSTRACT

Embodiments provide methods for the protection and consolidation of calcareous materials. An exemplary method includes providing an aqueous solution of a hydroxycarboxylic acid, adjusting the pH of the aqueous solution by adding an alkaline agent, and applying the pH-adjusted aqueous solution to a calcareous mineral to form a conversion layer on the mineral. The calcareous mineral may, for example, be carbonate rock, particularly limestone and marble, or may be part of masonry material, aggregates, or fillers. Adherent conversion layers are readily formed at ambient temperatures and, therefore, methods provided are suitable for field application. Conversion layers so formed are provided as further embodiments.

### RELATED U.S. APPLICATIONS

The present application is a Continuation-in-Part of application Ser. No. 09/852,975 filed May 10, 2001, which is a Continuation application of Ser. No. 09/428,713 filed Oct. 28, 1999, now U.S. Pat. No. 6,296,905, which claims priority from U.S. Provisional application No. 60/106,144, filed on Oct. 29, 1998, which are hereby incorporated herein by reference.

### TECHNICAL FIELD

This invention relates to the protection and consolidation of materials comprising alkaline calcareous minerals, especially limestones and marbles.

### BACKGROUND ART

It is well established that the deterioration of alkaline calcareous masonry materials incorporated, for example, into buildings, engineering structures, public and funerary monuments and outdoor sculpture is associated with chemical weathering. For architectural and sculptural stone, the principal mechanism of chemical weathering is acidic dissolution of the carbonate minerals calcite and aragonite (calcium carbonate) and dolomite (calcium magnesium carbonate). In rural areas, the acidity of fog, rainwater and snow may be limited by the solubility of carbon dioxide. Considerably lower values of pH (representing greater acidity) are recorded in urban industrialized areas, where sulfur dioxide is more abundant, is readily oxidized by ozone and nitrogen oxides, and the resultant sulfur trioxide dissolves in water to form sulfuric acid. The macroscopic results of acidic attack include erosion of stone profiles and of surface tooling and carving, loss of polish, the progressive illegibility of inscriptions, and dramatic disintegration.

Much of the prior art with regard to protection of calcareous stone has relied upon the use of film-forming sealers, including those based upon drying oils, plant resins, shellac, waxes, and more recently (that is, since the Second World War) acrylics and epoxies. Total failure of such sealer-based systems via entrapment of moisture behind the film is common, as is the embrittlement, clouding and discoloration of the films upon environmental exposure to ultraviolet radiation. Similarly poor results have been reported with regard to the application of water-repellents (such as stearates, silicones and fluoropolymers), largely because of their inability to remain attached to the chemically dynamic carbonate minerals outdoors.

Where deterioration has advanced to the stage of significant reduction of cohesive properties, attempts have been made to utilize many of the organic treatments noted above as consolidants (strengtheners). For solution polymers, entry into the weakened pore structure of the stone is typically impeded by the tendency of solvent evaporation to limit deposition of the consolidant to a zone near the stone surface. With chemically curing resin systems (such as two-part epoxies), their high viscosity is a critical factor, resulting in insufficient penetration and, therefore, poor performance.

Progress in the consolidation of deteriorated masonry materials with commercial strengthening formulations based on tetraethyl orthosilicate (TEOS) has been substantial since the early 1970's. Hydrolysis and condensation of this low viscosity liquid (sometimes blended with alkyltrialkoxysilanes to impart water-repellency to the cured consolidant) results in the formation of glassy deposits of silica. Unfortunately, the results achieved for the preservation of sandstones, brick, and other silicate building materials have not been equaled for carbonate-containing rocks. In fact, carbonate minerals have recently been shown to be anti-catalytic to the formation of silicate polymers derived from TEOS. Use of TEOS-based products is claimed to result in improved cohesion of deteriorated stone as a result of the development of chemical bonds to the stone surface. It is firmly believed that such bond formation requires hydroxyl groups, which are largely absent in calcite, aragonite and dolomite.

Other methods historically proposed and/or utilized for the preservation of limestones and marbles include the reaction of the carbonate minerals with aqueous solutions of fluorides, fluorosilicates, and barium hydroxide. Published results of both laboratory and field testing of these formulations strongly suggest that they are of questionable value, especially for marble.

Since the 1960's, there has been a great deal of research on the response of calcium hydroxide (synthetic portlandite) in concrete and other cement-based composites to environmental acidity. The dissolution of portlandite weakens the microstructure of these materials. The calcium carbonate that typically forms as a result of this process (called carbonation) is, itself, sensitive to acidic conditions and is susceptible to further attack (sulfation).

### SUMMARY OF THE INVENTION

An embodiment of the present invention provides a method of treating carbonate aggregate material to reduce alkali-aggregate reactivity. The method includes providing an aqueous solution of a hydroxycarboxylic acid. The acid may comprise L-(+)-tartaric acid. Further, the method includes adjusting the pH of the aqueous solution by adding an alkaline agent and applying the pH-adjusted aqueous solution to the carbonate aggregate material. A conversion layer formed on the aggregate material is also provided.

### BRIEF DESCRIPTION OF THE DRAWINGS

FIG. 1 is a plot of modulus of rupture, R, versus % aggregate retained; the plot derived from the data of Table III.

FIGS. 2-4 are plots of monitored pH versus time. The plot of FIG. 2 is derived from the data of Table IV for calcite, the plot of FIG. 3 is derived from the data of Table V for dolomite and the comparative plot of FIG. 4 is derived from the data of Table VI for treated and untreated aggregate.

### DETAILED DESCRIPTION OF SPECIFIC EMBODIMENTS

Embodiments of the present invention provide methods that form a conversion layer on the surface of alkaline calcareous minerals. The conversion layer is well adhered. It is rapidly formed at ambient temperatures. As an aqueous solution is used to form the layer, penetration of the treatment into masonry materials comprising such minerals is considerable, particularly if the material is significantly deteriorated. The newly formed chemical phase which makes up the conversion layer is shown to be hydroxy-functional, permitting reaction with TEOS-based consolidants, and with alkylalkoxysilanes and other reactive water-repellents. Rinsing with a secondary solution is shown to be useful, particularly on dolomite, because of the somewhat higher solubility of magnesium-containing reaction products. The secondary solution is also an aqueous solution. The conversion layer is acid-resistant and, when uniformly deposited, acts as a passivator, to provide protection from acid rain attack. As it is formed from the existing mineral surfaces, the conversion layer also serves to cement mineral grains together, by intergrowth, at points of grain contact. For some alkaline calcareous masonry materials, such intergrowth leads to a consolidating or strengthening effect, even in the absence of TEOS-based consolidants.

Although embodiments of the present invention result from research on the chemical preservation of limestone and marble, the process is applicable to all alkaline calcareous masonry materials. This includes (in addition to the carbonate rocks limestone and marble) mortar, stucco, plaster, cast-in-place concrete, cement-based block (CMU), glass fiber reinforced cement (GFRC) products and architectural precast panels. The treatment is also applicable to carbonate mineral aggregates and fillers, which are utilized in the aforementioned lime- and/or cement-based products, and in plastics, paints, caulks, sealants, block fillers and joint compounds.

The conversion layer is formed via a chemical reaction between calcite or aragonite (calcium carbonate), dolomite (calcium magnesium carbonate) or synthetic portlandite (calcium hydroxide) and pH-adjusted aqueous solutions of hydroxycarboxylic acids. Those acids include, but are not limited to, glycolic, lactic, malic and tartaric acids. The formation of the conversion layer takes place at ordinary ambient temperatures and the treatment is thus particularly suited for field application to architectural and sculptural materials. The reaction product is a conversion layer that is highly insoluble and well adhered, having active bonding sites. These sites promote more successful use of alkoxysilanes, including TEOS-based consolidants and alkyltrialkoxysilane (or other reactive) water-repellents. Evidence of the creation of bonding sites is to be found in the results of silicate film adhesion tests (described below as Examples 4 and 5) and strength measurements (see Examples 6 and 10), and in the distinctly different wetting characteristics of the conversion layer versus that of calcite (see Example 3).

In an exemplary embodiment, stable conversion layers are formed by reaction with aqueous solutions derived from L-(+)-tartaric acid. The chemical formula for tartaric acid is:

HOOC—CH(OH)CH(OH)—COOH

On calcite, the conversion reaction may be understood to proceed as follows:

TARTRATE ION+CALCITE/ARAGONITE+WATER-OOC—CH(OH)CH(OH)—COO+CaCO₃+4H₂+CO₃⁻² [symbol] Ca[OOC—CH(OH)CH(OH)—COO].4H₂O+CO₃⁻²CALCIUM TARTRATE TETRAHYDRATE+CARBONATE ION

Useful solutions may be prepared with L-(+)-tartaric acid at tartrate ion concentrations ranging from approximately 0.06 to approximately 0.25 mols per liter. pH-adjusted formulations are demonstrably reactive at pH values of between approximately 2.8 and approximately 5.0; the adjustments are effectuated by the addition of an alkaline agent, namely, concentrated ammonium hydroxide. Other suitable alkaline agents known in the art may be used. A narrower pH range of approximately 3.4 to 5.0 was established by observing gas evolution during test applications of the tartrate solutions to finely divided reagent grade calcium carbonate (no less than 99% passing a No. 100 screen, see Example 2, Table II). A pH of 3.9 at a tartrate ion concentration of 0.16 M, was determined to be an exemplary embodiment from the monitoring of pH during stirred treatment of screened calcite and dolomite marble aggregates, as described in Example 7.

As the solubility of L-(+)-tartaric acid in water at room temperature is quite high, it would seem possible to utilize a wide range of solution concentrations. However, very low tartrate ion concentrations do not result in the formation of a uniformly deposited conversion layer in a reasonable period of time. High concentrations are quite acidic and are, therefore, too aggressive to alkaline calcareous minerals. Digestion of these mineral surfaces during formation of the conversion layer compromises adhesion of the latter and acts to loosen individual grains. This is counterproductive to the utilization of the treatment on deteriorated masonry. Furthermore, evolution of carbon dioxide gas (from carbonate minerals) during application of such highly concentrated solutions of L-(+)-tartaric acid creates a back-pressure within the pore structure of the material being treated. As a result, the depth of penetration of the solution is reduced considerably. Additionally, upward adjustment of the pH by additional ammonium hydroxide adversely affects the reaction kinetics leading to the formation of the conversion layer. Therefore, there is a practical upper pH limit, particularly in applications for which the time required to form a stable conversion layer should be minimized.

Conversion treatment research was carried out on transparent crystals of calcite (Iceland spar) averaging 30 mm by 40 mm, and 14 mm in thickness. On these crystals, formation of the conversion layer may be readily observed with the naked eye. An initial problem was the difficulty of wetting the mineral surface. Useful solutions were prepared with an alcohol alkoxylate surfactant such as Triton XL-80N, at concentrations ranging from 0.02 to 0.15% (v/v). Verification of the reaction to form the conversion layer on the calcite crystals was made by identification of calcium tartrate tetrahydrate (JCPDS no. 26-330) via computer-interpreted x-ray diffraction (XRD) analysis.

During conversion treatment research directed toward dolomite, the greater solubility of magnesium tartrate hydrates, when compared with calcium tartrate tetrahydrate, needed to be addressed. Another embodiment of the methodology of conversion layer formation includes the use of a secondary solution. Limewater was successfully used as the secondary solution. Limewater is easily prepared from commercial grades of high calcium hydrated lime, an inexpensive material in common use in the agricultural and chemical industries. It is a saturated aqueous solution of calcium hydroxide. The saturation concentration is dependent on temperature. At room temperature, for example, the concentration is approximately 0.87 g/l.

Deep treatment with the secondary solution (after initial application of the tartrate solution) by rinsing a masonry surface including dolomite results in the double decomposition of the magnesium tartrate hydrates into the more stable calcium tartrate tetrahydrate and magnesium hydroxide (the latter is highly insoluble). Excess tartaric acid and/or mono- or diammonium tartrate that may remain from the primary treatment is consumed by precipitation of additional calcium tartrate tetrahydrate. This precipitation minimizes the formation of efflorescence directly associated with unreacted tartrates. This reaction can be understood as:

DIAMMONIUM TARTRATE+CALCIUM HYDROXIDE+WATER[OOOCCH(OH)CH(OH)COO]NH+Ca⁺⁺+2OH4H₂O [symbol] Ca[OOCCH(OH)CH(OH)COO].4H₂O+2H₂O+2NH₃CALCIUM TARTRATE TETRAHYDRATE+WATER+AMMONIA

Evolution of ammonia gas at this point can be quite noticeable by odor. As field differentiation of calcite from dolomite is often difficult, and both minerals sometimes occur within the same material, rinsing with the secondary solution should be routinely performed.

For a more detailed understanding with regard to calcareous stone (and to aggregates and fillers derived therefrom), reference is made to the following examples of research. They are presented herein for illustrative purposes only.

### EXAMPLE 1

Over one hundred and seventy Iceland spar (calcite) crystals have been treated by partial immersion in pH-adjusted aqueous tartrate solutions at room temperature (22° C.). These crystals, averaging 30 mm by 40 mm, and 14 mm in thickness, are from Creel (Chihuahua), Mexico. Most specimens were given two or three immersions, each in fresh solution. They were patted dry (with paper toweling) between immersions, rinsed with water after the final immersion, patted again, and allowed to air dry. Typical times for each immersion were between 1 and 16 minutes. pH of the test solutions ranged from 1.7 to 5.0, with tartrate ion concentrations ranging from 0.10 to 0.41 mols per liter. Criteria for judgment of the conversion treatment included uniformity of the layer, optical properties (variations of translucency), and adhesion. These characteristics were studied under a stereobinocular microscope at 7-30.times. magnification. Adhesion was assessed by the raggedness of the edges of scratches made through the layer with a steel stylus. This evaluation was done after air drying, which was visually judged to be complete approximately thirty minutes after water rinsing. Several of the test solutions gave excellent conversion layers with two or three immersions of at least four minutes per immersion. Representative observations and data for specimens treated with two four-minute immersions are presented in Table I, organized by pH.

TABLE I
(Refer to Example 1)

| pH | Tartrate ion, M | Uniformity | Optical properties | Adhesion |
|---|---|---|---|---|
| 2.13 | .410 | poor/variable | translucent | poor |
| 2.38 | .310 | poor/variable | translucent | poor |
| 2.75 | .210 | poor | translucent | N/A |
| 2.90 | .100 | complete | nearly opaque | very good |
| 3.02 | .215 | complete | nearly opaque | very good |
| 3.16 | .152 | complete | nearly opaque | excellent |
| 3.18 | .175 | complete | nearly opaque | very good |
| 3.40 | .152 | complete | translucent | very good |
| 3.45 | .110 | complete | translucent | very good |
| 3.52 | .175 | complete | nearly opaque | excellent |
| 3.62 | .115 | complete | poorly translucent | very good |
| 3.94 | .175 | complete | nearly opaque | excellent |
| 4.63 | .245 | complete | poorly translucent | very good |
| 4.85 | .250 | fair | nearly transparent | poor |
| 5.02 | .120 | barely visible | transparent | N/A |

### EXAMPLE 2

The fourteen representative pH-adjusted aqueous tartrate solutions listed in Table I were reacted with finely divided, reagent grade calcium carbonate (no less than 99% passing a No. 100 screen). Observations of gas evolution are presented in Table II. A narrowed, practical pH range of approximately 3.4 to 5.0 was established. At pH values of less than 3.4, moderate to vigorous gas evolution was observed. Such gas evolution is counterproductive to the utilization of such solutions on deteriorated masonry comprising alkaline calcareous minerals.

TABLE II
(Refer to Example 2)

| | | Observation of |
|---|---|---|
| pH | Tartrate ion, M | gas evolution |
| 2.13 | .410 | vigorous |
| 2.38 | .310 | vigorous |
| 2.75 | .210 | vigorous |
| 2.90 | .100 | moderate |
| 3.02 | .215 | moderate |
| 3.16 | .152 | moderate |
| 3.18 | .175 | moderate |
| 3.40 | .152 | slight |
| 3.45 | .110 | slight |
| 3.52 | .175 | slight |
| 3.62 | .115 | very slight |
| 3.94 | .175 | very slight |
| 4.63 | .245 | none |
| 4.85 | .250 | none |
| 5.02 | .120 | none |

### EXAMPLE 3

Drops of sulfuric acid at concentrations of 0.001 M (pH 2.9) and 0.01 M (pH 2.0) were placed on more than thirty treated Iceland spar crystals, and on more than twenty untreated controls. Conversion treatment was performed by immersion (two four-minute immersions) in many pH-adjusted aqueous tartrate solutions. Test solutions that seemed most promising were determined from Examples 1 and 2. In particular, solutions having a tartrate ion concentration of 0.175 M and pH ranging from 3.2 to 3.9 were used. Observation of the results was made with a stereobinocular microscope and with the unaided eye. Etching of the controls occurred within a few minutes, at both sulfuric acid concentrations. The effects of acid contact are more difficult to assess on treated crystals because the optical properties of the conversion layer are similar to those of an acid-etched crystal. The acid drops were therefore allowed to evaporate (overnight) to dryness.

First, no damage to the conversion layers was observed, even when examined in raking illumination. Second, a dramatic difference in contact angle between controls and treated samples was observed. This difference is indicative of the hydroxy-functional nature of the calcium tartrate tetrahydrate conversion layer. Treated crystals were repeatedly washed to verify that the contact angle difference was not attributable to residual surfactant.

### EXAMPLE 4

Individual Iceland spar (calcite) crystals were treated with two pH-adjusted tartrate test solutions; the first was 0.10 M at a pH of 2.9, while the second was 0.175 M at a pH of 3.9. Conversion treatment was with three four-minute immersions following the general procedure described in Example 1. A commercial TEOS-based consolidant (Conservare OH, supplied by ProSoCo, Inc., Lawrence, Kans., denoted “OH”), designed to deposit glassy silica, was applied by brush to a single treated face of each crystal. The same consolidant was brushed on untreated crystals as controls. The OH consolidant was allowed to cure for at least two weeks. When touched lightly with a wooden probe, all cured silicate films on the controls were found to be unattached to the calcite. Without exception, cured silicate films on treated crystals (with a conversion layer) were, by contrast, very well adhered.

### EXAMPLE 5

At least twenty-four Iceland spar (calcite) crystals were treated (three four-minute immersions) with a pH-adjusted aqueous tartrate solution of 0.175 M and a pH of 3.9. After sufficient drying, the crystals were bound together in pairs (“couplets”), with similarly-sized faces in contact. Six couplets of untreated crystals were assembled as experimental controls. The commercial TEOS-based consolidant (Conservare OH) utilized in the experiments described in Example 4 was fed into the edge of the minute gap between the bound crystals, the liquid being drawn in by capillarity. For some couplets, this was done a single time; for others, OH was introduced weekly over a period of more than twenty-eight days. All assembled couplets were allowed to cure undisturbed for at least two weeks after the final application of the Conservare OH. The bindings were then cut. Untreated couplets showed no evidence of attachment. Couplets made of treated crystals were well adhered and could be handled without caution.

### EXAMPLE 6

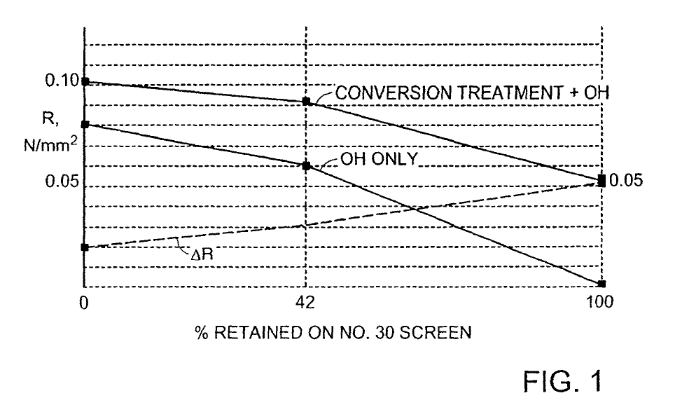

Crushed dolomite marble aggregate (MarbleMix DF-1000, Specialty Minerals, Canaan, Conn.) was screened to provide two batches: the first, passing a No. 30 screen; the second, retained on the No. 30 screen. A third batch utilized the aggregate as received (42% retained on the No. 30 screen). Half of each batch was treated with a pH-adjusted aqueous tartrate solution of 0.10 M at a pH of 2.9. The treatment included four four-minute stirred baths, the first three baths of tartrate solution, the last bath of saturated aqueous calcium hydroxide (secondary solution). The other half of each batch was kept as a control, creating a total of six test groups of aggregates. Twelve to fifteen weighed samples of each of the six test groups were mixed to an essentially uniform paste consistency with appropriate amounts of Conservare OH, and the paste placed into 60 mm diameter polystyrene petri dishes. The filled dishes were allowed to cure indoors, uncovered, for two weeks, at which time an additional 6 ml of OH was added to each dish. After a further two weeks, fifty-two petri dishes were lightly scored on their edges, and the cast disks un-molded. For the untreated aggregate retained on No. 30 screen, there was no consolidating effect at all with OH. These samples disintegrated during un-molding. The other five sets of samples held together well, and were tested for modulus of rupture (R, in N/mm.sup.2), utilizing an apparatus described elsewhere by E. M. Winkler in APT Bulletin, XVII (2), 35-37 (1985). Data are presented in Table III and R is plotted from the data in FIG. 1. Carbonate mineral aggregates treated with the tartrate solution created significantly stronger disks, with greater increases in flexural strength as the aggregate size was increased. For the sets that utilized unscreened aggregate, there was a 51% increase in flexural strength as a result of the conversion treatment.

TABLE III
(Refer to Example 6)

| | % | Number of | Mean | R | ΔR (N/(mm²) |
|---|---|---|---|---|---|
| | Retained | samples | loan, N | (N/mm²) | (% increased) |
| Untreated | 0 | 10 | 24.5 | 0.081 | |
| Treated | 0 | 6 | 30.8 | 0.102 | .021 (26%) |
| Untreated | 42 | 10 | 18.5 | 0.061 | |
| Treated | 42 | 8 | 27.8 | 0.092 | .031 (51%) |
| Untreated | 100 | 8 | (0) | (0) | |
| Treated | 100 | 10 | 15.3 | 0.051 | .051 (N/A) |

### EXAMPLE 7

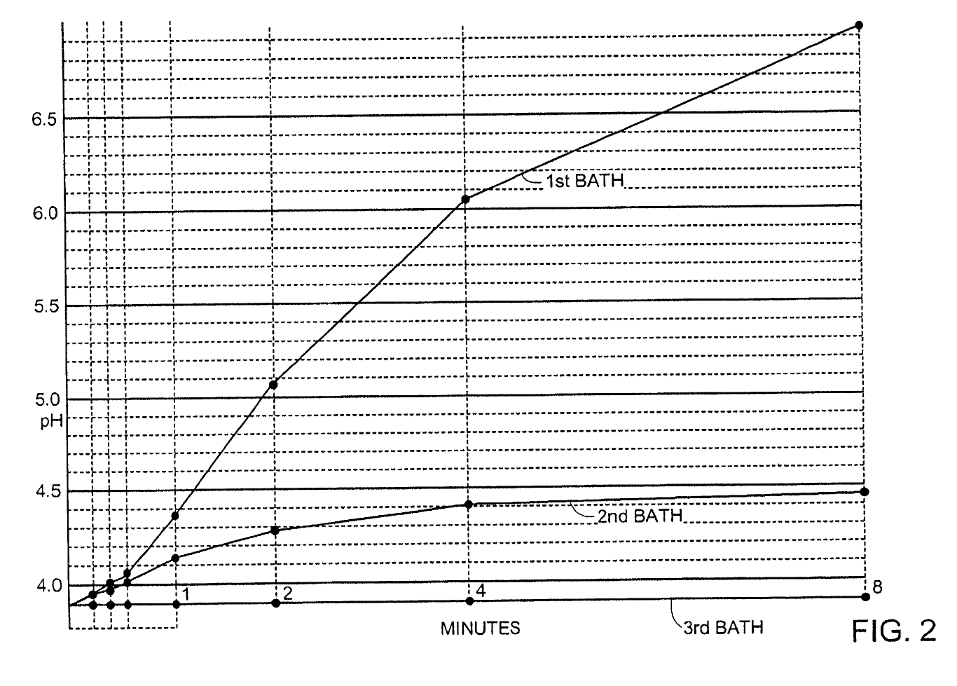

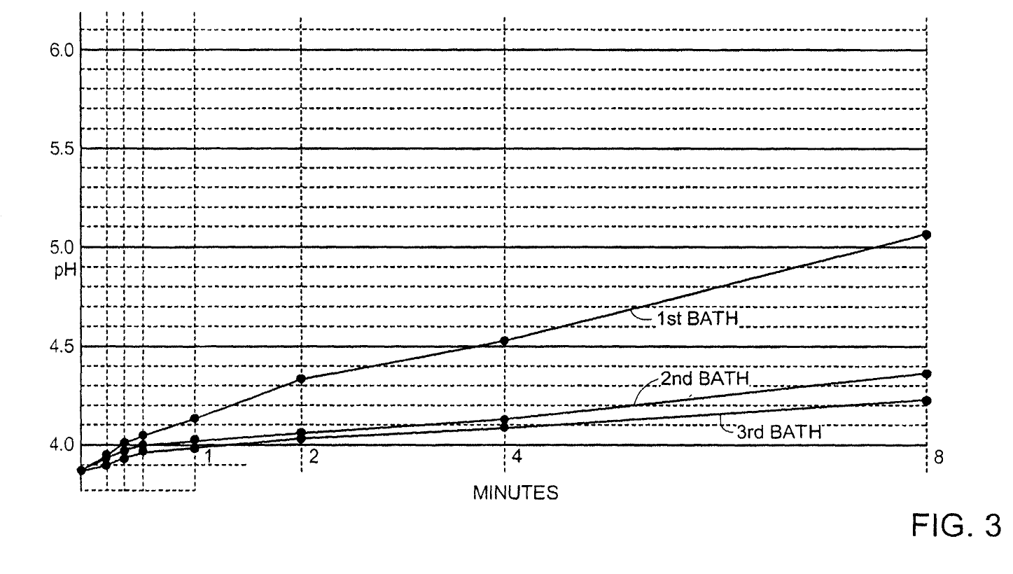

Crushed dolomite marble (MarbleMix DF-1000) and calcite marble (AFG 10-40, Specialty Minerals, Adams, Mass.) aggregates were water washed and dried, and screened to pass a No. 50 screen and be retained on a No. 100 screen. For calcite, 4 g of aggregate was treated with 20 ml of a tartrate solution of 0.16 M at a pH of 3.9, with continuous stirring for eight minutes. The solution was decanted, the aggregate dried, and the process repeated twice, each time with fresh solution. pH was monitored with a digital meter as a function of time, and the data plotted. The pH electrode was in the stirring bath continuously during each eight-minute period. The same procedure was carried out with dolomite, stirring 20 g into 20 ml of the same treatment solution. Mean data from triplicate experiments are presented graphically (FIG. 2—calcite and FIG. 3—dolomite) and in tabular form in Tables IV (calcite) and V (dolomite). Increasing pH represents neutralization of the tartrate solution by reaction with the alkaline carbonate minerals. With repeated treatment on the same particles, the increase is progressively less, as there are fewer tartrate-reactive locations left on the mineral surfaces. In other words, the conversion treatment becomes more complete. The need to use a larger amount of dolomite to observe this process is consistent with the greater resistance of dolomite (versus calcite) to acidity, as commonly reported in the literature.

TABLE IV
(Refer to Example 7)

1^{st} Bath

| Time | | Average | 2^{nd} Bath | 3^{rd} Bath |
|---|---|---|---|---|
| elapsed | pH | deviation | pH | Ph |
| 10 sec | 3.95 | .01 | 3.96 | 3.90 |
| 20 sec | 4.01 | .01 | 4.00 | 3.90 |
| 30 sec | 4.06 | .01 | 4.03 | 3.90 |
| 1 min | 4.37 | .02 | 4.15 | 3.91 |
| 2 min | 5.06 | .02 | 4.29 | 3.91 |
| 4 min | 6.02 | .06 | 4.41 | 3.91 |
| 8 min | 6.91 | .01 | 4.45 | |

TABLE V
(Refer to Example 7)

1^{st} Bath

| Time | | Average | 2^{nd} Bath | 3^{rd} Bath |
|---|---|---|---|---|
| elapsed | pH | deviation | pH | Ph |
| 10 sec | 3.93 | .01 | 4.01 | 3.96 |
| 20 sec | 3.99 | .01 | 4.02 | 3.98 |
| 30 sec | 4.05 | .01 | 4.02 | 3.98 |
| 1 min | 4.16 | .00 | 4.06 | 4.00 |
| 2 min | 4.31 | .00 | 4.09 | 4.03 |
| 4 min | 4.53 | .02 | 4.17 | 4.11 |
| 8 min | 5.03 | .04 | 4.35 | 4.26 |

### EXAMPLE 8

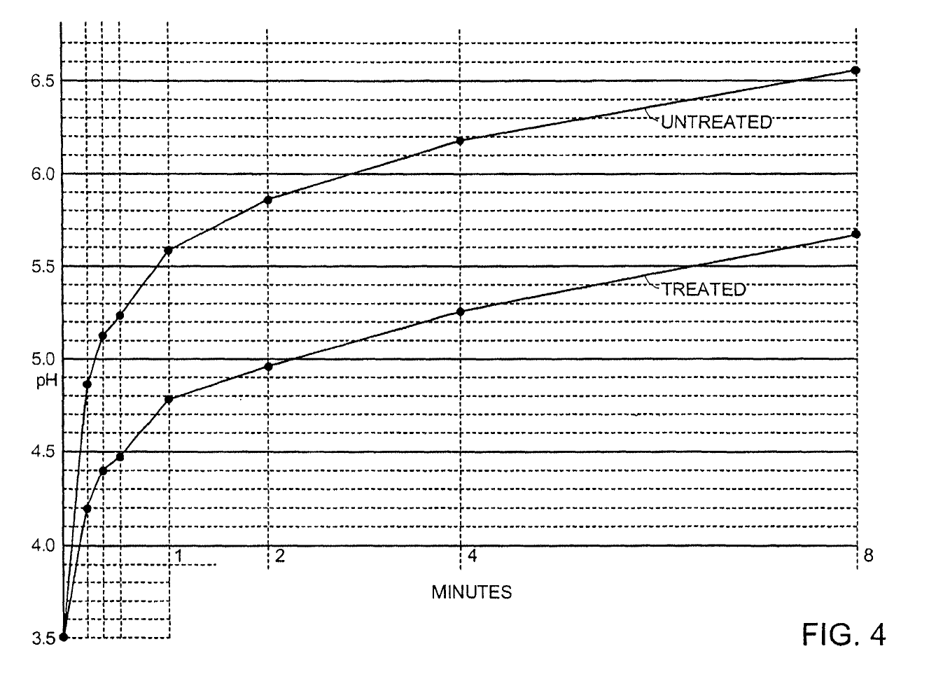

The aggregate used for this Example was the treated calcite marble aggregate from Example 7 (three baths). 4 grams of this treated aggregate was then stirred for eight minutes in 20 ml of an acid rain “simulant” composed of carbonic and sulfuric acids at room temperature (22.degree. C.), saturated with respect to carbon dioxide. The pH of the “simulant” solution was 3.5. This is an order of magnitude more acidic than acid rain typically observed in the northeastern United States. During stirring, pH was measured as a function of time, as described in Example 7. This experiment was performed in triplicate. The same procedure (also in triplicate) was carried out on untreated aggregate and both sets of mean data (Table VI) were plotted (FIG. 4). The curve for the untreated aggregate shows a much more rapid increase in pH (indicating greater reactivity) in the first minute of exposure. The two curves are nearly parallel thereafter, with a consistent difference of approximately 0.9 pH units. As pH values are on a logarithmic scale, this represents an eight-fold reduction in sensitivity to acid exposure as a result of the conversion treatment.

TABLE VI
(Refer to Example 8)

| | |
|---|---|
| Treated | Untreated |

| Time | | Average | | Average |
|---|---|---|---|---|
| elapsed | pH | deviation | pH | deviation |
| 10 sec | 4.18 | .05 | 4.85 | .00 |
| 20 sec | 4.36 | .05 | 5.11 | .00 |
| 30 sec | 4.46 | .04 | 5.26 | .02 |
| 1 min | 4.68 | .04 | 5.59 | .02 |
| 2 min | 4.93 | .03 | 5.87 | .04 |
| 4 min | 5.23 | .03 | 6.18 | .02 |
| 8 min | 5.61 | .06 | 6.52 | .00 |

### EXAMPLE 9

More than sixty-five small cores (each 13.7 mm in diameter) were prepared from a large baluster that had been removed by the National Park Service from the Grant Memorial, in Washington, D.C. The stone was identified by petrographic microscopy as “second statuary Rutland,” a calcite marble quarried near West Rutland, Vt. After 90 years of weathering, the stone was in poor condition. Five cores from the base of the baluster were tested in direct tension, using a modification of ASTM D 2936-95, which requires samples of a larger size. (Measurement of the applied tensile load was with an Imada PS 100 Mechanical Force Gauge, on a custom-built test stand.) Four pairs of base cores, with weathering surfaces intact, were adhered surface-to-surface with a structural epoxy. Each surface-coupled pair was similarly tested in tension to assess surface soundness.

For comparison, eight other cores were treated with a pH-adjusted aqueous tartrate solution of 0.175 M at a pH of 3.8 by capillarity, through the weathered surface. The solution was introduced in three thirty-second absorptions, with thirty minutes of air drying in between, followed by a one-minute capillary absorption of a saturated aqueous calcium hydroxide (secondary) solution. Treated cores were then surface-coupled and tested. They showed a mean strength in crease of 124% versus the untreated cores. Utilizing the single core data for tensile failure (failure which occurred more than 20 mm below the weathered surfaces) for comparison, -this increase represents a “return” to 82% of the presumed (original) soundness of the marble. In untreated condition, the core surfaces were at 37% of unweathered tensile strength. The data confirm that formation of the conversion layer, even in the absence of OH consolidation, can result in significant improvements in the cohesive properties of carbonate rocks.

### EXAMPLE 10

Fourteen cores from the central portion of the marble baluster discussed in Example 9 were organized into four test groups: untreated; consolidated with Conservare OH; treated with a pH-adjusted aqueous tartrate solution of 0.175 M and a pH of 3.8; and, treated with the tartrate solution followed by the OH consolidant. Testing was in tension on surface-coupled pairs (as described in Example 9.) Treatment with the tartrate solution resulted in a mean strength increase of 75% versus the untreated pairs. Use of only OH (one cycle, performed by capillarity [per the manufacturer's current laboratory protocol]) gave a 26% increase. The sequential method (that is, conversion treatment followed by OH) resulted in an increase of 126%. The much greater increase is attributable to the attachment of the OH consolidant to bonding sites in the conversion layer.

To date, numerous badly deteriorated fragments and complete gravestones and obelisks in rural cemeteries in western New England have been treated to form conversion layers. Conversion treatment has resulted in considerable improvement of surface soundness. Field exposure studies of large groups of marble samples (both calcite and dolomite) are ongoing.

The conversion treatment is of interest for many alkaline construction industry composites including (but not limited to) those having binders of lime, of portland cement, or of lime-cement blends. For lime-based and lime-cement composites, the cured binder contains considerable amounts of calcium carbonate. This makes these materials particularly sensitive to chemical weathering. Treatment of such composites (typically mortars, stucco and plasters) results in the improvements observed for limestones and marbles, namely, the formation of bonding sites to facilitate preservation with alkoxysilane consolidants and water-repellents, accompanied by increased cohesion and acid rain resistance.

For cured cement-based composites (including cast-in-place concrete, CMUs, GFRC and architectural precast), conversion treatment serves to reduce carbonation, by reaction with the portlandite that has formed during cement hydration. (Hydroxycarboxylic acids have a history of use as admixtures in the cement products industry.) Sulfation is also reduced, by reaction with the calcium carbonate that results from carbonation.

In some instances, cement-based composites-such as concretes, decorative precast blocks and panels, and patching compounds-incorporate limestone or marble aggregates and/or fillers. These can be improved by conversion treatment as loose material prior to manufacture, to result in better in-service performance of the final product via enhanced adhesion of the cement paste, and increased acid rain resistance of these aggregates and/or fillers.

The conversion treatment, in yet another embodiment, can be utilized as a primer for alkaline calcareous masonry materials, significantly enhancing the adhesion of cementitious mortars, grouts and patching compounds. Conversion treatment can also increase the adhesion of cementitious, silicate and silicone-based paints and coatings, as well as silicone caulks, adhesives and sealants. These observable improvements are the direct consequence of the bonding sites formed by the development of the conversion layer.

First reported in the early 1940s, a number of carbonate aggregates exhibit a significant level of alkali-aggregate reactivity. Another benefit of forming a conversion layer, by the methodology described above, on carbonate aggregates, is to minimize this reactivity. For example, the term dedolomitization was recently coined to describe an alkali-aggregate reaction resulting in the breakdown of dolomite (calcium magnesium carbonate) into calcite (CaCO3) and brucite (Mg(OH)2). Treatment of dolomite aggregates prior to their incorporation into concrete or other material tends to inhibit such a reaction by altering surface chemistry.

The description of the specific embodiments of the methods and uses of the conversion layer for protection and consolidation of calcareous material in terms of constituents, concentrations, and methods of application and uses, is presented herein for the purposes of illustration and description. It is not intended to be exhaustive nor to limit the scope of the invention to the specific forms described herein. Although the invention has been described with reference to several preferred embodiments, it will be understood by one of ordinary skill in the art that various modifications can be made without departing from the spirit and the scope of the invention, as set forth in the claims hereinbelow.

We claim:

1. A method of treating carbonate aggregate material to reduce alkali-aggregate reactivity comprising:
providing an aqueous solution of a hydroxycarboxylic acid;
adjusting the pH of the aqueous solution by adding an alkaline agent; and
applying the pH-adjusted aqueous solution to the carbonate aggregate material, thereby reducing reactivity by forming a conversion layer on the carbonate aggregate material.

2. A method according to claim 1, wherein, in providing, the aqueous solution comprises L-(+)-tartaric acid.

3. A method according to claim 1, further comprising:
rinsing the carbonate aggregate material with a secondary solution.

4. A method according to claim 3, wherein, in rinsing, the secondary solution comprises calcium hydroxide.

5. A method according to claim 1, wherein the carbonate aggregate material comprises dolomite.

6. A conversion layer formed at a surface of carbonate aggregate material by the method of claim 1.
